(19) United States
(12) Patent Application Publication
(10) Pub. No.: US 2020/0066118 A1
(43) Pub. Date: Feb. 27, 2020

(54) APPARATUS AND METHOD FOR INDICATING LOAD LEVEL OF VEHICLE

(71) Applicant: Anthony Wiggins, Port Orange, FL (US)

(72) Inventor: Anthony Wiggins, Port Orange, FL (US)

(21) Appl. No.: 16/111,839

(22) Filed: Aug. 24, 2018

(51) Int. Cl. G08B 7/06; G01G 19/08; G01G 23/36; B60D 1/24

(52) U.S. Cl. CPC G08B 7/06; G01G 19/08; B60G 2300/04; B60D 1/248; G01G 23/36

(57) ABSTRACT

An apparatus for warningly indicating a current load weight of a vehicle is presented. The load warning apparatus includes a pressure sensor associated with a pressure line of a vehicle for producing a plurality of pressure signals representative of a corresponding plurality of amounts of load weights. A load weight indicator activity is based on the pressure for indicating current load level of a vehicle. Lamps are lit to give visual indication of the status of the load level of the vehicle.

### FIELD OF THE INVENTION

This present invention relates to the field of vehicle electronic systems and, more particularly, to an apparatus to indicate a current load level of a vehicle.

### BACKGROUND

Over the years, the heavy-duty vehicle industry has used tractor and trailer combinations to transport cargo over the roadways to various desired destinations. The tractor and trailer are conventionally mechanically coupe together so that the tractor efficiently and effectively pulls the trailer. Often, one or more additional trailers are also mechanically coupled to another trailer so that only one tractor pulls a plurality of trailers.

Associated with these various tractor/trailer combinations or trucks, various systems have been developed which provide a vehicle operator, a vehicle driver, or other third parties with the weight of a load in the trailer or associated with the truck. These systems, for example, can include sensors mounted to the trailer or truck, a cab mounted display, load supporting air bags, and bag supported platforms or other mounting structures.

These systems are used to determine the weight of the vehicle while operating the vehicle. Currently, the only mechanism to know the current usage of a trailer prior to connecting the trailer to a truck cab is to manually open the vehicle. While this is costly in labor time, it also does not indicate whether the trailer is ready to be connected and is not overloaded. A mechanism could also be used to circumvent overloaded trailers from being placed on the road and thus increasing safety for all that navigate the road system.

### BRIEF DESCRIPTION OF THE DRAWINGS

FIG. 1 is a view of the inside of a trailer showing sensors.

FIG. 2 is the view of the back of a trailer with indicator lights.

FIG. 3 is a close-up view of one type of load indicator system.

FIG. 4 is a close-up view of an embodiment of the load indicator system.

FIG. 5 is a close-up view of an embodiment of the indicator lights.

### DETAILED DESCRIPTION

Reference will now be made in detail to the present preferred embodiments, examples of which are illustrated in the accompanying drawings. All terms in the plural shall also be taken as singular and vice-versa. Further, any reference to he shall also be applicable to she and vice-versa.

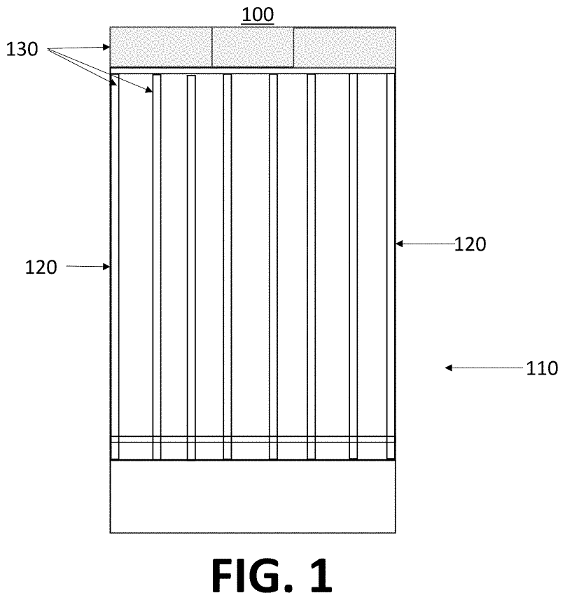

FIG. 1 presents a view of the inside of a trailer 100. The trailer 100 is a cargo holder for over-land transport of goods from one location to another location. The trailer can be various lengths, but for long-haul transport of goods, the trailer 100 is generally fifty-three (53) feet long. The trailer 100 is coupled to a truck cab, not shown. The truck cab contains an engine and at least on seat for the driver to sit and control the vehicle.

The trailer 100 is generally empty at the outset of loading the trailer 100 for transporting goods. The trailer 100 thus has a weight associated with it that would indicate that the trailer 100 is empty. The trailer 100 then loaded with goods for delivery to various locations. There are guidelines set forth by federal and state governments on the maximum capacity that can be carried in a trailer 100. Thus, the weight of the trailer 100 is important for legally transporting goods for delivery.

In FIG. 1, the trailer has doors 110, the doors 110 are open in this example. The doors 110 of the trailer 100 may be either split doors 110 that fold outwards and then when closed are latched in the middle. The doors 110 of the trailer 100 may also be a roll-type door. The roll-type doors are flexible and when open are rolled upwards to allow access to the cargo area. The roll-up type door is latched at the bottom for security.

The cargo area of the trailer 100 has lights 120 along each side to allow a user to have easy vision as to the dimensions of the trailer 10. These lights 120 may be off when the door 110 is closed. The lights 120 are generally white in color but may be of any color to allow a user to see the outlines of the cargo area.

The cargo area of the trailer 100 has a series of sensors 130 for determining the capacity and/or the weight of the cargo being carried in the trailer 100. The sensors 130, as depicted, are lined in the walls and top of the trailer 100. The sensors 130 are coupled to a control board for receiving the signals from the sensors 130 and determining the weight of the load in the trailer 100. The weight is then compared to the known empty capacity of the trailer 100. If the weight is greater than the known weight of the empty capacity, then the weight is compared to the maximum weight allowed for the trailer 100. Various indicators will be described in detail later in this application.

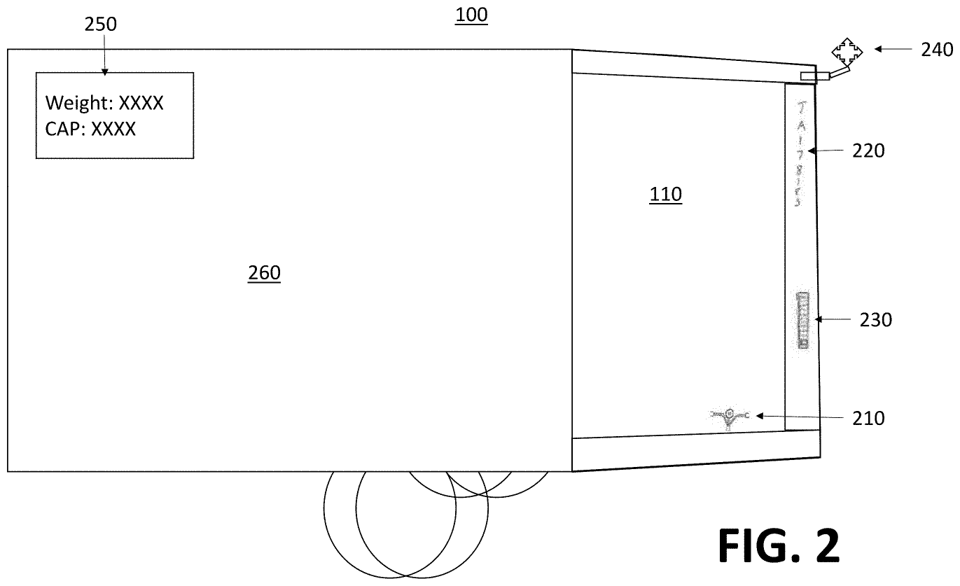

Moving now to FIG. 2, the back of the trailer 100 is shown when the doors 110 are closed. The latch 210 is applied to the closure system of the trailer 100 to secure the doors 110 in the closed position. In most cases, a lock is then applied to the latch 210 to keep intruders from accessing the cargo carried in the trailer 100, and to keep the latch 210 from coming unlatched and allowing the doors 110 to open while the trailer 100 is in transport. Further, the trailer 100 has a serial number or trailer number 220 for easy determination as to the trailer 100 being coupled to the truck cab.

The trailer 100 has at least one light 230 to be used to indicate the status of the load of the trailer 100. This at least one light 230 allows a user to know the status prior to coupling the truck cab to the trailer 100. Therefore, in cases when trailers are inadvertently coupled to the wrong truck cab or are coupled to the truck cab prior to being fully loaded will be more easily avoided and save the trucking company time and money. The at least one light 230 can be of any color or lights may be lit to different colors.

Optionally, the trailer 100 has a camera 240. The camera 240 is mounted to the rear top of the trailer 100 on the passenger side of the trailer where the camera 240 is maneuverable to capture a view from either the back of the trailer 100 or along the side of the trailer 100. The camera 240 may be any camera available and although the embodiment shows the camera 240 in the upper right-hand corner of the rear of the trailer 100 the camera 240 may be located at any location on the trailer 100.

Optionally or in another embodiment, the trailer 100 has a display panel 250. The trailer 100 has a driver side 260. The driver side 260 of the trailer 100 has a display panel 250 which receives the determined weight of the trailer 100. The determined weight is displayed on the display panel 250. The determined weight displayed on the display panel 250 of the trailer 100, allows for the driver or other worker to determine the actual weight and whether the trailer 100 can be further loaded, is overloaded or the weight to be used if the trailer 100 were to be in tandem with another trailer and the total weight could be ascertained. Though the display panel 250 is described as on the driver side 260 of the trailer 100, the placement of the display panel 250 may be anywhere along the exterior of the trailer 100 which may be convenient and easy to access by a potential driver.

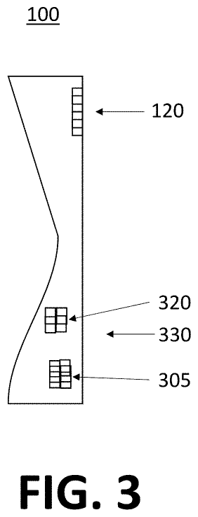

Turning now to FIG. 3, a load level indicator system 305 is shown. The load indicator is coupled to the back of the trailer 100. The load level indicator system 305 has one or more lights 120 to be used to indicate the load status of the trailer 100. The one or more lights 120 can be of any color that can be used to determine the load status of the trailer 100.

In the preferred embodiment, green would be used to indicate an empty trailer 100, yellow indicates that the trailer 100 is at or below the maximum weight allowed by law but the trailer is not empty. In addition, a red light being lit would indicate that the trailer 100 has exceeded the weigh limits, an alarm can be sounded options to alert the user to the condition of the trailer 100. The alarm is sounded through speaker 320 of the load level indicator system 305. The load reader 330 is also shown on the back of the trailer 100 as the control panel for the system.

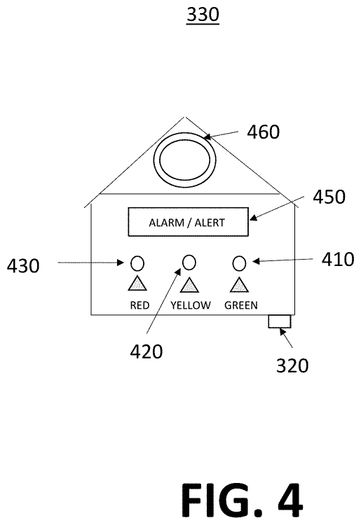

FIG. 4 describes an embodiment of the load level indicator 330. The load level indicator 330 has three lamps, a first lamp 430, a second lamp 420, and a third lamp 410. As described earlier, the third lamp 410 is preferably lit red when the cargo load for the trailer 100 has exceeded the maximum capacity allowed, the second lamp 420 is preferably lit yellow when the cargo load for the trailer 100 is at or below the maximum capacity allowed but is also not empty, and the first lamp 430 is preferably lit green when the trailer 100 is determined to be empty.

A speaker 320 is shown that is used to alert the user of the current load level status of the trailer 100. Optionally, an alarm/alert lamp 450 is shown that is lit when the cargo load has been determined to have exceeded the maximum load level for the trailer 100.

In another embodiment, the load level indicator 330 has an on/off switch 460. The on/off switch 460 of the load level indicator 330 allows the user to power down the system to conserve energy.

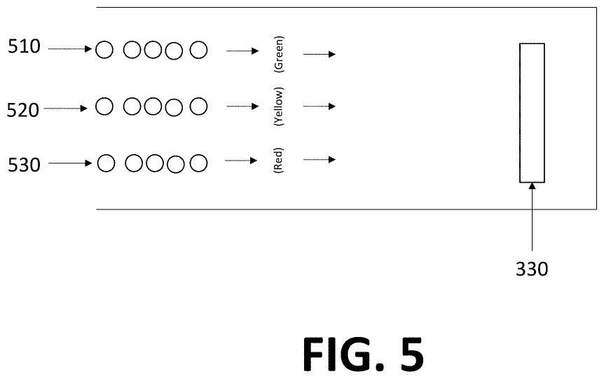

Referring now to FIG. 5, an alternative embodiment is shown for the load level indicator 330. The lamps are arranged such that there are at least three (3) rows of a plurality of lamps for each type of indication status.

The first of the at least three rows of lamps are one or more green lamps 510. The one or more green lamps 510 indicate that the cargo area of the trailer 100 is empty.

The second of the at least three rows of lamps are one or more yellow lamps 520. The one or more yellow lamps 520 indicate that the cargo load of the trailer is no greater than the maximum load allowed but the trailer 100 is not empty.

The third of the at least three rows of lamps are one or more red lamps 530. The one or more red lamps 530 indicate that the cargo load of the trailer 100 has exceeded the maximum weight capacity allowed for the trailer 100.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

I claim:

1. An apparatus for warningly indicating a load weight of a vehicle, the apparatus comprising:
a pressure sensor associated with a pressure line of a vehicle for producing a plurality of pressure signals representative of a corresponding plurality of amounts of loaded weights;
a load weight indicator responsive to said pressure sensor for indicating a plurality of amounts of send load weight levels, said load weight indicator including a memory for storing at least a calibration signal representative of a predetermined maximum desired load weight limit level and an empty load weight, said memory and sensor for comparing the calibration signal to the plurality of pressure signals;
a determinator for comparing the load weight indicator to determine a current load of the vehicle; and
a light panel for indicating the determined current load level of the vehicle.

2. The apparatus of claim 1, wherein the current load of the vehicle indicates the vehicle to be empty.

3. The apparatus of claim 2, wherein the light panel is lit green.

4. The apparatus of claim 1, wherein the current load of the vehicle indicates the vehicle to no greater than a maximum allowed weight and not empty.

5. The apparatus of claim 4, wherein the light panel is lit yellow.

6. The apparatus of claim 1, wherein the current load of the vehicle indicates the vehicle weight to have exceeded the maximum weight limit.

7. The apparatus of claim 6, wherein the light panel is lit red.

8. The apparatus of claim 6, further comprising an alarm speaker, wherein the alarm speak is active to alert of overweight vehicle.

9. The apparatus of claim 1, wherein the light panel is one lamp.

10. The apparatus of claim 1, wherein the light panel is positioned on the back of the vehicle.

11. The apparatus of claim 1, wherein the light panel contains a plurality of rows of lamps.

12. The apparatus of claim 13, wherein at least one of the plurality of rows of lights is lit to indicate the current load level of the vehicle.

13. The apparatus of claim 1, further comprising a power controller, wherein the power controller is an on/off switch.

14. A method to indicate a load level of a vehicle, the method comprising:
determining a pressure on a sensor of the vehicle;
sending the determined pressure to a control board;
determining the weight of the vehicle at the control board;
comparing the determined weight of the vehicle to a stored trailer empty weight, wherein when the determined weight is equal to an empty weight a signal is sent to light a first lamp;
when the determined weight is not equal to the empty weight, comparing the determined weight to the maximum weight allowed, wherein if the compared determination is not greater than the maximum allowed weight sending a signal to light a second lamp;
when the determined weight is greater than the maximum weight allowed sending a signal to light a third lamp.

15. The method of claim 14, wherein the first lamp is green.

16. The method of claim 14, wherein the third lamp is yellow.

17. The method of claim 14, wherein the third lamp is red.

18. The method of claim 14, wherein when the weight is greater than the maximum weight allowed an alarm is sounded.

19. The method of claim 14, wherein the first lamp is more than one lamp.

20. The method of claim 14, further comprising an on/off switch, wherein the determining the pressure on the sensor of a vehicle is controlled by the on/off switch position.
